(19) United States
(12) Patent Application Publication
(10) Pub. No.: US 2018/0001287 A1
(43) Pub. Date: Jan. 4, 2018

(54) Blender with Single Fill Opening and Continuous Product Discharge

(71) Applicant: L.B. Bohle Maschinen und Verfahren Gesellschaft mit beschränkter Haftung, Ennigerloh (DE)

(72) Inventor: Lorenz Bernhard Bohle, Ennigerloh (DE)

(21) Appl. No.: 15/632,303

(22) Filed: Jun. 24, 2017

(30) Foreign Application Priority Data
Jun. 29, 2016 (DE) 20 2016 103 469

(51) Int. Cl. B01F 15/04; B01F 7/16; B01F 3/08; B01F 5/12; B01F 5/00; B01F 3/00

(52) U.S. Cl. CPC B01F 15/042; B01F 3/08; B01F 5/12; B01F 7/162; B01F 3/00; B01F 5/00

(57) ABSTRACT

A blender has a tubular mixing chamber that is provided with an interior and is arranged horizontally. A fill opening and an outlet opening communicate with the interior of the tubular mixing chamber. The fill opening and the outlet opening are spaced apart from each other in an axial direction of the tubular mixing chamber by a length distance. A rotatably driven shaft extends in the axial direction lengthwise through the interior of the tubular mixing chamber and is provided with mixing members that are projecting radially outwardly into the interior of the tubular mixing chamber. The shaft has a region without mixing members, wherein the region without mixing members is located in front of the outlet opening and adjoining the outlet opening. The region without mixing members has a length that amounts to between ⅕ of the length distance and ½ of the length distance.

### BACKGROUND OF THE INVENTION

The invention relates to a blender comprising a horizontally aligned tubular mixing chamber with a fill opening, an outlet opening arranged spaced apart from the fill opening in axial direction by a length distance, and with a rotatably driven shaft that extends in longitudinal direction through the mixing chamber and comprises mixing members that extend radially outwardly into the material to be mixed.

Blenders of the aforementioned kind are known in practice. They are also referred to as “continuous blenders” and are designed to provide a product flow as continuous as possible that is discharged through the outlet opening of the blender and supplied into downstream components of a production facility. Blenders of the aforementioned kind are used, for example, in the pharmaceutical industry where they provide, for example, a product mixture which is then processed to tablet cores in a downstream granulating device.

The invention has the object to improve a blender of the aforementioned kind in that the blender enables with a configuration as cost-effective as possible a material discharge at the outlet opening that is as continuous as possible.

### SUMMARY OF THE INVENTION

In accordance with the invention, this is achieved in that the shaft comprises a region in front of the outlet opening and adjoining the outlet opening that has no mixing members, wherein the region has a length that is between ⅕ and ½ of the length distance between the fill opening and the outlet opening.

Turning away from the conventional configuration of a blender, the invention proposes in other words not to provide mixing members up to a point at a short spacing in front of the outlet opening but, instead, provide a region in front of the outlet opening in which the shaft has no mixing members. This region is significantly larger than a constructively required region that is, for example, only amounting to a few millimeters or a few centimeters in which, in conventional blenders, the mixing members are arranged in front of an end face of the mixing chamber. According to the invention, this region without mixing members has such a length in front of the outlet opening that it extends across ⅕ to ½ of the length distance between the fill opening and the outlet opening of the mixing chamber.

The present invention is based on the consideration that, due to the horizontal alignment of the mixing chamber, the material flows anyway automatically to the outlet opening because of the material which is continuously added through the fill opening into the mixing chamber and due to the mechanical movement acting on the material through the mixing members. Since the mixing members do not extend to a position very close to the outlet opening, the effect is avoided that a mixing member arranged close to the outlet opening conveys material to the outlet opening in batches in temporal intervals as a function of the rotary speed of the shaft. Due to the region which is without mixing members, this batch-wise or intermittent conveying action, effected for each revolution of the shaft by means of the mixing member which is the last one in the conveying direction, i.e., closest to the outlet opening, is made more uniform. Since, as proposed, this free region, i.e., region without mixing members, amounts to ⅕ to ½ of the length distance between the fill opening and the outlet opening, a sufficiently more uniform conveyance is provided so that the batch-wise or intermittent action of the last mixing member essentially does not exert a corresponding batch-wise or intermittent conveyance up to the outlet opening; instead, at the outlet opening an essentially continuous material flow is effected and accordingly a production facility arranged downstream can be supplied practically continuously with material from the blender according to the invention.

Depending on whether the tubular mixing chamber is aligned exactly horizontally or with a slight slant, for example, oriented with a downward slant toward the outlet opening, the free region without mixing members can amount to up to ½ of the length distance between fill opening and outlet opening. For a free region without mixing members of ½ of the length distance, the conveying action that is provided by the last mixing member is essentially not effective at the outlet opening. When the mixing chamber however extends at a downward slant toward the outlet opening, a continuous product flow up to the outlet opening can be reliably produced nevertheless.

In order to provide a thorough blending of the material, it is advantageous when the shaft is furnished with mixing members along a longer section than only half of the length distance (L), i.e., the spacing between the fill opening and the outlet opening. Practical tests have demonstrated that advantageously the region that is without mixing members can have a length that is between ⅕ and ⅓ of the length distance (L). In this way, due to the greater number of mixing members furnished on the shaft, on the one hand, a more thorough mixing or blending of the product is ensured and, on the other hand, a sufficiently long free region without mixing members is provided in order to make the material flow more uniform and in order to avoid that the batch-wise or intermittent conveying action of the mixing members can still be effective or acting all the way to the outlet opening.

Advantageously, the mixing chamber can comprise the aforementioned fill opening as the sole fill opening for the material to be mixed or blended. Not only by saving mixing members due to the free region without mixing members but also due to the fact that no additional fill openings are provided, a particularly economic configuration of the blender is promoted.

For a blender as proposed that comprises a region without mixing members, so-called auxiliary members can be provided on the shaft, in particular also in the region that is without mixing members. The auxiliary members have a significantly reduced effect on the material to be mixed or blended than the mixing members; in particular, they are less effective in regard to the mixing or blending action so that, accordingly, they do not cause an intermittent or interval-like or batch-wise product flow at the outlet opening of the mixing chamber.

However, the auxiliary members in a first embodiment, for example, by an appropriate slanted position, can impart to the material to be mixed or blended a slight movement in the direction toward the outlet opening and thus ensure a flow of the material to be mixed in axial direction through the mixing chamber even in the region in which no mixing members are arranged which otherwise not only effectively blend but also convey the material to be mixed due to their configuration.

In a second embodiment, the auxiliary members can however also be configured to effect conveyance in the opposite direction away from the outlet opening toward the fill opening in order to cause the material to back up so that, when a certain backed-up quantity of material to be mixed has formed, the material to be mixed, by overcoming the auxiliary members, is flowing uniformly to the outlet opening. In this way, for example, too low a filling level of material in the mixing chamber that would impair uniform material flow can be avoided.

According to a third embodiment, it can be provided that the auxiliary members have deliberately no conveying action at all in axial direction through the mixing chamber, but exclusively serve for loosening the material to be mixed in order to avoid in this way that the material to be mixed in the region of the mixing chamber that is without mixing members will adhere to the wall of the mixing chamber and as a result of a so-called stick/slip effect will reach the outlet opening of the mixing chamber in jerks, i.e., in intervals or intermittently.

### BRIEF DESCRIPTION OF THE DRAWING

Embodiments of blenders according to the invention will be explained in the following with the aid of purely schematic illustrations in more detail.

FIG. 1 is a vertical longitudinal section of a first embodiment of a blender.

FIG. 2 is a plan view of a basically similar but conventionally designed blender.

FIG. 3 is a schematic further simplified longitudinal section, similar to FIG. 1, of a second embodiment.

FIG. 4 is a partial cross section of the blender of FIG. 3.

### DESCRIPTION OF PREFERRED EMBODIMENTS

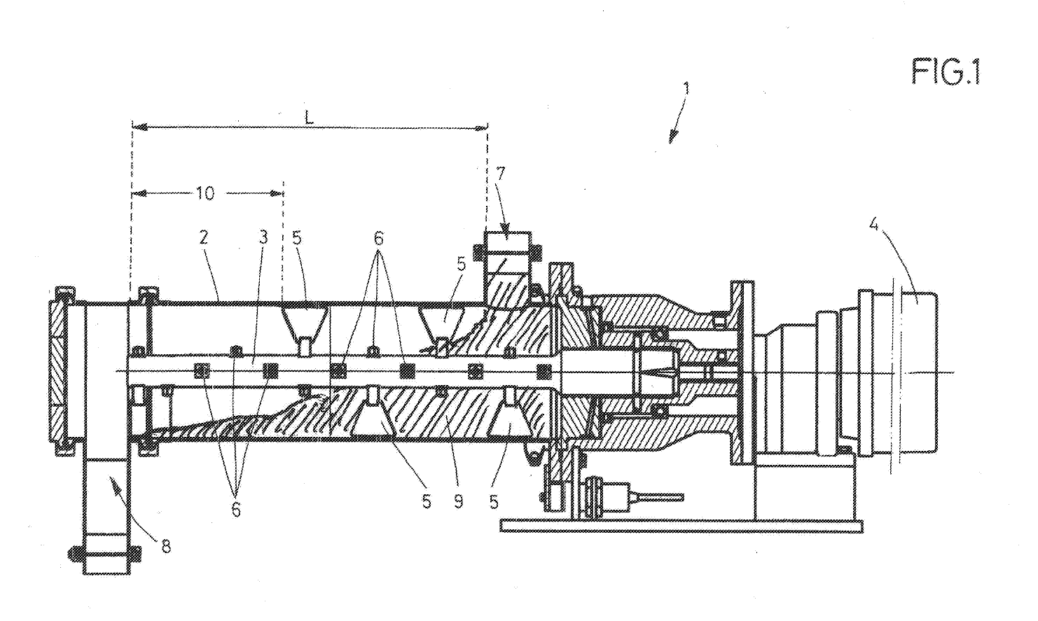

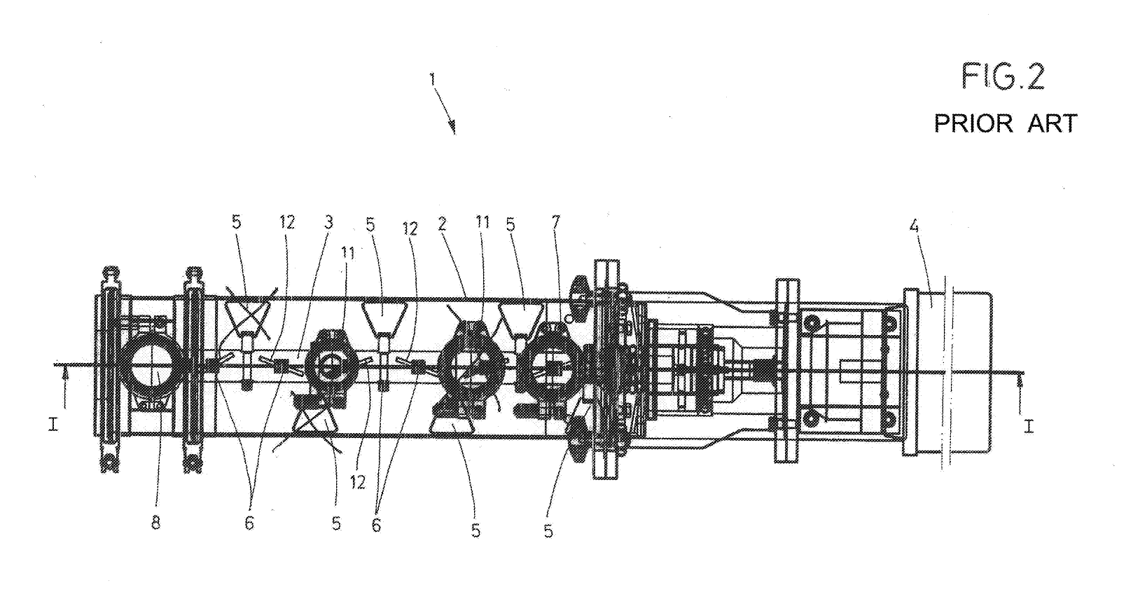

In the drawings, comparable components are identified with the same reference characters even if they are differently designed in different embodiments. Reference numeral 1 refers to the blender as a whole, wherein FIG. 1 illustrates the blender 1 according to the invention in a view which corresponds, with the exception of a few differences in construction to be explained in the following, to a vertical section along the line I-I of the conventional blender in FIG. 2.

The blender 1 comprises a tubular mixing chamber 2. A shaft 3 extends axially and centrally through the interior of the mixing chamber 2. This shaft 3 is caused to rotate by motor 4. The shaft 3 supports several mixing members 5 which can also be referred to as paddles. The shaft 3 comprises a plurality of receptacles 6 where a mixing member 5 or another component can be attached to the shaft 3, respectively.

The mixing chamber 2 comprises a single fill opening 7 as a feed opening in order to introduce material to be mixed or blended into the interior of the mixing chamber 2. The material flows from the fill opening 7 axially in longitudinal direction through the interior of the mixing chamber 2 until it reaches an outlet opening 8. The spacing between the fill opening 7 and the outlet opening 8 has a length distance L. The material which has been fed through the fill opening 7 into the interior of the mixing chamber 2 is illustrated in FIG. 1 in cross hatching and is identified by reference numeral 9. It is apparent that, due to the single fill opening, the material 9 is not uniformly distributed about the entire length of the mixing chamber 2 or across the entire length distance L. Instead, the filling level of the material 9 in the mixing chamber 2 decreases continuously from the fill opening 7 toward the outlet opening 8. First, an intensive mixing or blending of the material 9 by means of the mixing members 5 is taking pace. Downstream, there is however a region 10 within which the shaft 3 is without mixing members 5. The material 9 in this region 10 is only conveyed by means of the upstream material 9 that is continuously supplied wherein the effect of the last mixing member 5 which is closest to the outlet opening 8 is hardly noticeable at the outlet opening 8 so that therefore an intermittent or batch-wise action of this mixing member 5 on the material 9 does not cause an intermittent or batch-wise discharge of the material 9 from the blender 1. To the contrary, a practically continuous material flow is effected at the outlet opening 8 by the blender 1 of the invention.

FIG. 2 shows a plan view of a basically similar blender which differs with regard to the following aspects from the proposed blender 1 according to the invention that is shown in FIG. 1.

The conventional blender according to FIG. 2 comprises mixing members 5 arranged on the shaft 3 all the way into close proximity to the outlet opening 8. The two last mixing members 5 in FIG. 2 are crossed out in order to illustrate that these two mixing members 5 are not present in the proposed blender 1 according to FIG. 1.

Secondly, the blender of FIG. 2 differs from the proposed blender 1 according to FIG. 1 in that in addition to the fill opening 7 there are two additional openings 11 at the top of the mixing chamber 2; in the configuration of the blender 1 in accordance with the invention, these additional openings are eliminated, as shown in FIG. 1.

Finally, the shaft 3 of the conventional blender according to FIG. 2 is also provided with elements in the area of additional receptacles 6: aside from the mixing members 5, the blender of FIG. 2 also has so-called auxiliary members 12 which, in contrast to the mixing members 5, are designed to be significantly less effective with regard to blending action.

In deviation from the illustrated embodiment of FIG. 1, auxiliary members similar to the auxiliary members 12 can be provided on the shaft 3 of the proposed blender 1 according to the invention, in particular also in the region 10 that is without mixing members 5. The auxiliary members 12 have a significantly reduced effect on the material 9 and therefore do not produce to the same extent as the mixing members 5 an intermittent or interval-like or batch-wise product flow at the outlet opening 8. However, for example, by having an appropriate slanted position, they can impart to the material 9 a movement in the direction toward the outlet opening 8 and therefore can ensure flow of the material 9 in axial direction through the interior of the mixing chamber 2 even in the region 10 so that the material 9 is not conveyed exclusively by the upstream supplied material 9 in the direction toward the outlet opening 8.

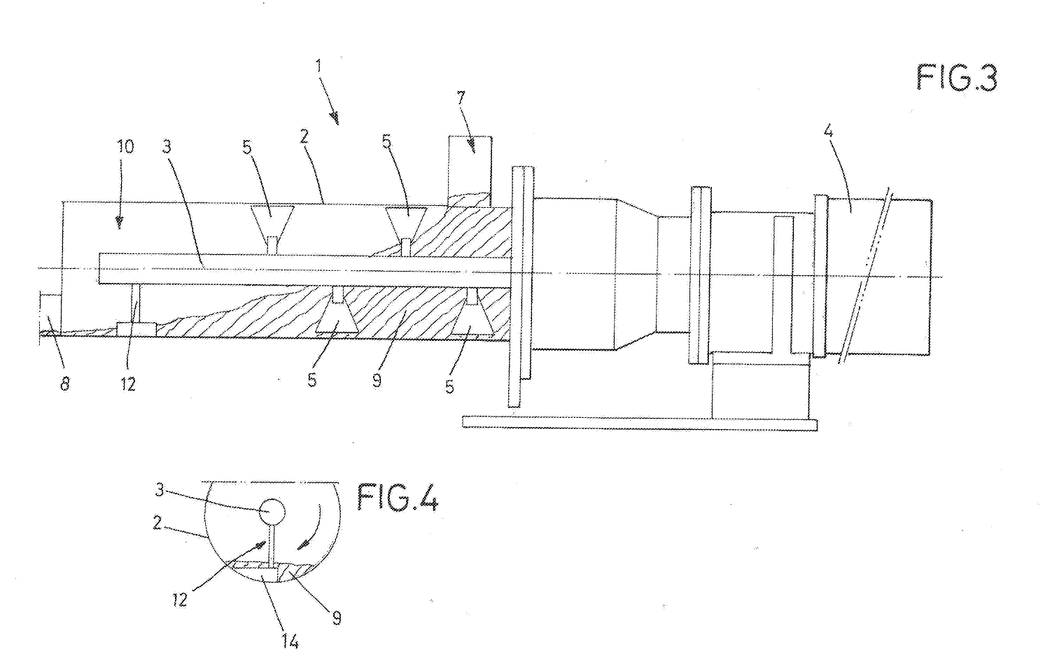

FIG. 3 shows an embodiment of a blender 1 that is designed in accordance with the invention but, as described above, is provided with an auxiliary member 12 in the region 10 that is without mixing members 5. In this embodiment, it is provided that the auxiliary member 12 imparts no movement at all in axial direction to the material 9, for example, toward the outlet opening 8.

Instead, the auxiliary member 12 comprises a flat shoe 14 that is in particular illustrated in FIG. 4 and is moving in close proximity along the wall of the mixing chamber 2 in order to reliably engage the material 9 which has only a minimal layer thickness or height in the region 10 within the mixing chamber 2. With the aid of the rotational direction indicated in FIG. 4 illustrating how the auxiliary member 12 on the shaft 3 is moving through the mixing chamber 2, it is apparent that the shoe 14 has a substantially wedge-shaped and continuously rising contour and therefore lifts the material 9 when moving through the material 9.

The effect of the auxiliary member 12 therefore does not reside in moving the material 9 in the conveying direction toward the outlet opening 8; instead, the shoe 14 is deliberately designed in such a way that such a conveying action is avoided. Instead, the auxiliary member 12 serves to lift the material 9 and thereby loosen it. Due to the upstream material 9 fed in through the fill opening 7 and pushing against the material 9 which is present in the region 10, a certain compression of the material 9 within the region 10 may occur. Depending on which kind of material is to be processed as material to be mixed in the blender 1, this compaction can cause a stick/slip effect in that the material 9 initially adheres or sticks to the inner side of the wall of the mixing chamber 2 and only after overcoming a certain break-off moment suddenly slides farther toward the outlet opening 8. This effect would impair the desired continuity of the material flow in the area of the outlet opening 8 and would lead instead to a batch-wise or intermittent material discharge from the outlet opening 8. Due to the auxiliary member 12 loosening of the material 9 is realized so that compaction and the possibly resulting stick/slip effect are counteracted.

The specification incorporates by reference the entire disclosure of German priority document 20 2016 103 469 having a filing date of Jun. 29, 2016.

While specific embodiments of the invention have been shown and described in detail to illustrate the inventive principles, it will be understood that the invention may be embodied otherwise without departing from such principles.

What is claimed is:

1. A blender comprising:
a tubular mixing chamber arranged horizontally and comprising an interior;
a fill opening communicating with the interior of the tubular mixing chamber;
an outlet opening communicating with the interior of the tubular mixing chamber, wherein the fill opening and the outlet opening are spaced apart from each other in an axial direction of the tubular mixing chamber by a length distance;
a rotatably driven shaft extending in the axial direction lengthwise through the interior of the tubular mixing chamber and comprising mixing members that are projecting radially outwardly into the interior of the tubular mixing chamber;
wherein the shaft comprises a region without mixing members, wherein the region without mixing members is located in front of the outlet opening and adjoining the outlet opening, wherein the region without mixing members has a length that amounts to between ⅕ of said length distance and ½ of said length distance.

2. The blender according to claim 1, wherein the length of the region without mixing members amounts to between ⅕ of said length distance and ⅓ of said length distance.

3. The blender according to claim 1, wherein the fill opening is the only fill opening of the tubular mixing chamber.

4. The blender according to claim 1, wherein the tubular mixing chamber is slanted downwardly toward the outlet opening.

5. The blender according to claim 1, wherein the shaft further comprises at least one auxiliary member which is configured to be less effective in regard to a mixing action in comparison to the mixing members.

6. The blender according to claim 5, wherein the at least one auxiliary member is arranged in the region without mixing members.

7. The blender according to claim 6, wherein the at least one auxiliary member is configured to effect movement of a material to be mixed in the tubular mixing chamber in a direction toward the outlet opening.

8. The blender according to claim 6, wherein the at least one auxiliary member is configured to effect no movement of a material to be mixed in the tubular mixing chamber in a direction toward the outlet opening.
